(19) United States
(12) Patent Application Publication
(10) Pub. No.: US 2012/0215614 A1
(43) Pub. Date: Aug. 23, 2012

(54) SYSTEMS AND METHODS FOR AUTOMATICALLY PROVIDING RELEVANT OFFERS TO CUSTOMERS

(75) Inventors: Thomas Hochstatter, Austin, TX (US); John Leonard, Austin, TX (US); Christopher McKinzie, Lakeway, TX (US)

(73) Assignee: American Express Travel Related Services Company, Inc., New York, NY (US)

(21) Appl. No.: 13/029,760

(22) Filed: Feb. 17, 2011

(51) Int. Cl. G06Q 30/00

(52) U.S. Cl. 705/14.27

(57) ABSTRACT

Disclosed is a method including determining, by a computer based system for managing a rewards program, an assignment for transaction account data associated with a first transaction account. Thereafter, the first transaction account is assigned to a first population of a plurality of populations based on the transaction account data. Thereafter, an offer comprising an offer criteria is received from an offeror. Thereafter, the offer criteria is analyzed to identify a subset of the plurality of populations. The subset comprises the first population. Thereafter, the offer is communicated to the subset of the population.

### FIELD OF INVENTION

The present disclosure generally relates to providing offers, and more particularly, to enable merchants to automatically provide customized promotional offers to customers.

### BACKGROUND

Merchants have been offering their customers offers (coupons) which may be redeemed by customers from the merchants' partner companies. The purpose of providing these offers is to provide the customers incentives to buy certain items from the partner company. As a result, the customers realize economical benefits, while the items of the partner companies are marketed among the customers. The coupons may offer customers discounts on products and services, a rebate, a gift card and the like.

Merchants are increasingly seeking innovative ways to send the coupons to their customers. One recent approach is to send coupons via text messaging. In certain mobile coupon advertising systems, customers request to receive the coupon via text messaging. For example, a merchant could advertise a “short code” address and keywords in a traditional manner, e.g., on billboards or radio. Customers could address a text message to the short code address and include one of the keywords in the body of the message to request text messages containing coupons related to the keyword. Using these systems, customers may not know which partner companies are located proximate to the customers' current location, or customers could receive a text message with a coupon that must be redeemed at a partner company located far away from the customer.

Other mobile coupon advertising systems allow customers to specify a location of interest, for example by sending a zip code along with a keyword in the body of a text message. However, coupons that are received in response are not customized to the customers' particular interests or real-time location. For example, if the customer requests coupons for restaurants in an area, coupons could be provided for restaurants that are of no interest to the consumer.

In some cases, random coupons are automatically provided by the merchant to customers without any input from customers. If these coupons are not of interest to customers, it causes a lot of inconvenience and frustration for customers. In current systems, there is no provision for customers to receive the coupons based his/her customized requirements.

Given the foregoing, a long felt need exists for an effective system for merchants to automatically provide relevant offers to customers.

### SUMMARY OF THE INVENTION

The present disclosure meets the above-mentioned needs by providing new and useful methods, systems and computer program products for providing financial product offerings based on customer's financial, lifestyle and behavior related data.

According to one embodiment, there is disclosed a method for providing relevant offers to customers. The method includes determining, by a computer based system for managing a rewards program, an assignment for transaction account data associated with a first transaction account. The method further includes assigning the first transaction account to a first population of a plurality of populations based on the transaction account data. The method furthermore includes receiving, from an offeror, an offer comprising offer criteria and analyzing the offer criteria to identify a subset of the plurality of populations, wherein the subset comprises the first population. The offer is then communicated to the subset.

### BRIEF DESCRIPTION OF THE DRAWINGS

The features and advantages of the present disclosure will become more apparent from the detailed description set forth below when taken in conjunction with the drawings, in which like reference numbers indicate identical or functionally similar elements. Additionally, the left-most digit of a reference number identifies the drawing in which the reference number first appears.

FIG. 1 is an exemplary environment in which offer module for providing relevant offers may be deployed, according to an embodiment;

FIG. 2 is an exemplary implementation of the offer module for providing relevant offers to customers, according to an embodiment;

FIG. 3 is a flowchart illustrating one example process for providing relevant offers to customers, according to an embodiment; and

FIG. 4 is a block diagram of an exemplary computer system, according to an embodiment.

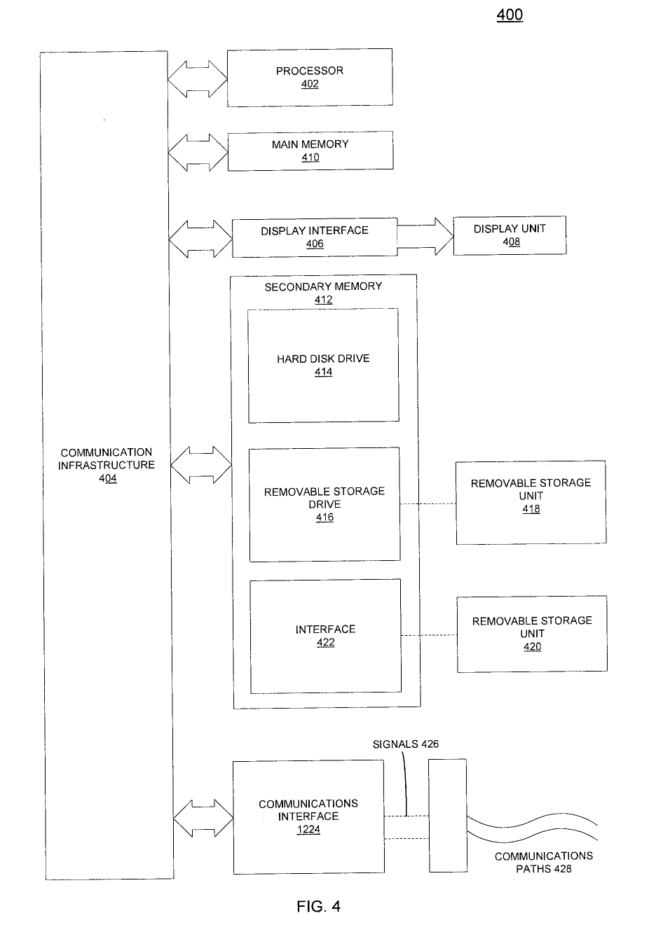

### DETAILED DESCRIPTION OF THE INVENTION

### I. Overview

The detailed description of exemplary embodiments herein makes reference to the accompanying drawings and figures, which show the exemplary embodiments by way of illustration only. While these exemplary embodiments are described in sufficient detail to enable those skilled in the art to practice the disclosure, it should be understood that other embodiments may be realized and that logical and mechanical changes may be made without departing from the spirit and scope of the disclosure. It will be apparent to a person skilled in the pertinent art that this disclosure can also be employed in a variety of other applications. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the systems (and components of the consumer operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present disclosure is described herein with reference to system architecture, block diagrams and flowchart illustrations of methods, and computer program products according to various aspects of the disclosure. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise in any number of configurations including the use of windows, web pages, hypertexts, hyperlinks, web forms, popup windows, prompts and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

### Terminology

A “merchant”, as used herein, may include any individual, business, entity, group, charity, software and/or hardware that desire to offers goods or services for sale. For example, a merchant may be a restaurant that wishes to offer a discount to consumers within a defined geographic proximity of the restaurant location. In the context of the present application, the merchant may also be termed as an “offeror.”

A “consumer”, as used herein, may include any individual, business, entity, group, charity, software and/or hardware that desires to utilize the system to obtain promotional items or purchase items from a merchant. “Account holders”, or similar phrases as used herein, may include any individual, group, charity, entity, software and/or hardware that is associated with an account in certain ways, such as a user, customer, member, rights holder, benefit from the account, affiliated with the account and/or the like. Transaction account holders may include all (or any subset of) account holders associated with a particular issuer, account holders with a certain type of account, primary account holders, subsidiary account holders, relatives of account holders, responsible parties of account holders, parties impacted by the account and/or the like. It is noted that the terms “customer,” “consumer,” “user”, “account holder” and “population” may be used interchangeably herein.

An “offer”, as used herein, may include any discounts, awards, items, gift card, rebate on any products and/or services provided by a merchant.

“Item” may include any good, service, information, experience, event, show, access, restriction, monetary value, loyalty points, non-monetary value and/or the like.

It is further noted that a “mobile communications device” may include, for example, any of cellular telephones, beepers, pagers, iPods®, personal digital assistants (PDAs), Blackberry® type devices and/or any device capable of being moved from one location to another.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to affect such feature, structure, or characteristic in connection with other embodiments whether or not explicitly described.

The systems, methods and computer program products disclosed in conjunction with various embodiments of the present disclosure are embodied in a systems and methods for intelligently providing offers to a plurality of populations. The nomenclature “offers” is only exemplary and used for descriptive purposes, and must not be construed to limit the scope of the present disclosure.

The present disclosure is now described in more detail herein in terms of the above disclosed exemplary embodiments of system, processes and computer program products. This is for convenience only and is not intended to limit the application of the present disclosure. In fact, after reading the following description, it will be apparent to one skilled in the relevant art(s) how to implement the following disclosure in alternative embodiments.

### II. System

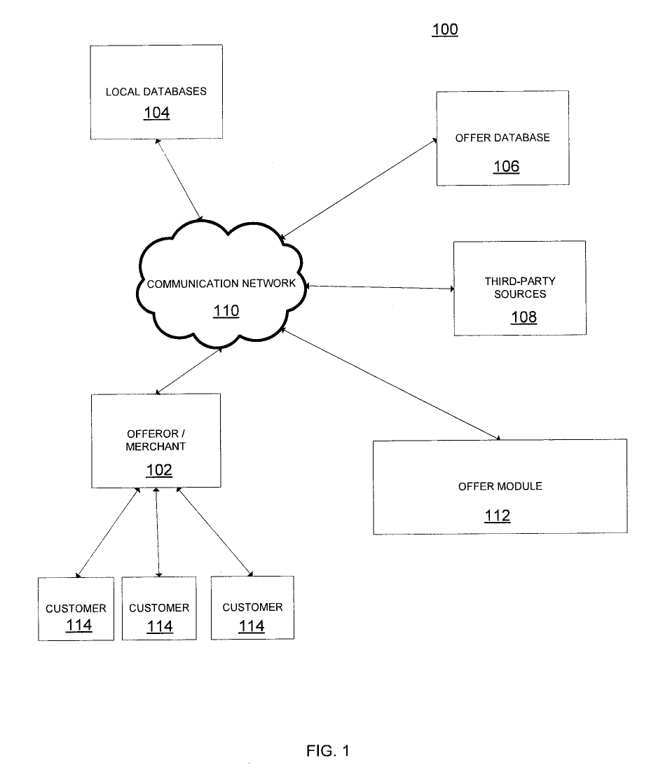

FIG. 1 shows an exemplary environment 100 in which the present disclosure may be utilized. Environment 100 includes an offeror 102 (also referred to as “merchant”), local databases 104, an offer database 106, third-party sources 108 and a communication network 110. Merchant 102, local databases 104, offer database 106, third-party sources 108 may communicate with each other over communication network 110. Examples of communication network 110 may include, for example, a wide area network (WAN), a local area network (LAN), an Ethernet, Internet, an Intranet, a cellular network, a satellite network, or any other suitable network for transmitting data. Communication network 110 may be implemented as a wired network, a wireless network or a combination thereof.

Merchant 102 may comprise any hardware and/or software suitably configured to facilitate input, receipt and/or review of information relating to intelligent offering program or any information discussed herein. Offer database 106 and local databases 104 may include any device (e.g., personal computer), which communicates (in any manner discussed herein) with merchant 102 via any network discussed herein. These computing units or systems may take the form of a computer or set of computers, although other types of computing units or systems may be used, including laptops, notebooks, hand held computers, set-top boxes, workstations, computer-servers, main frame computers, mini-computers, PC servers, pervasive computers, network sets of computers, and/or the like. Practitioners will appreciate that local databases 104 and offer database 106 may or may not be in direct contact with merchant 102. For example, merchant 102 may access the services of local databases 104 and offer database 106 through another server, which may have a direct or indirect connection to communication network 110.

As those skilled in the art will appreciate, merchant 102 may include an operating system (e.g., Windows 7, Windows XP, Windows NT, 95/98/2000, 0S2, UNIX, Linux, Solaris, MacOS, Android, etc.) as well as various conventional support software and drivers typically associated with computers. Further, Merchant 102 may include any suitable personal computer, network computer, workstation, minicomputer, mainframe or the like. Furthermore, merchant 102 may be in a home or business environment with access to a network. In an exemplary embodiment, access is through a network or the Internet through a commercially available web-browser software package.

In an exemplary implementation as shown in FIG. 1, an offer module 112 may be communicatively coupled to merchant 102 through communication network 110. In an embodiment, offer module 112 may be deployed on one or more servers associated with merchant 102. Offer module 112 may be deployed as a separate entity on a third party server. Although offer module 112 is described herein in terms of providing intelligent offers, it will be readily apparent to one skilled in the art that a similar offer module may be deployed for other types of products/services such as, but for example, offering financial transaction instruments, open transaction instruments, loans, insurance plans, travel packages, retail goods and the like. Offer module 112 may enable merchant 102 to intelligently provide offers that may of relevance to customers 114. Offer module 112 may map customers 114 to most relevant offers that may be provided by merchant 102 based on one or more analytics performed on data related to customers 114 stored in local database 104 and third-party sources 108.

The information stored on local databases 104 may include customers' 114 personal information including a name, an address, current geographical location, gender, age, other demographic information, contact details, such as e-mail address, phone number, correspondence address, social security number, and the like. Further, local databases 104 may store transaction history of customers 114, account receivable information, credit bureau information, transaction account data associated with customers 114, historical offers provided to customers 114, record of offers acceptance from customers 114, financial triggers of customers 114, lifestyle triggers of customers 114, one or more preference setting of customers 114 and data from third party sources 108. For example, local databases 104 may store customer's bank account related data such as account transactions, opening balance, closing balance, average balance over a period of time, interest earned over a period of time, preference criteria for receiving offers, etc. As used herein, any data/information stored on a local database may also be stored on other databases (local or remote), and accessed or obtained by the system.

Further, local databases 104 may also store account history of merchant 102, offers provided to one or more customers 114 by merchant 102, offers accepted by customers 114 that are provided by particular merchant 102 etc.

In various embodiments, offer module 112 may retrieve the financial data from various third party sources 108, such as, for example, banks, credit bureaus, financial institutions, and/or dedicated companies/agencies (for example, “comScore Networks Inc.”) that may provide such information.

Further, local databases 104 may store customers' lifestyle related data; e.g., whether the customer frequently travels by air or whether customer spends a significant amount of money in shopping or whether the customer's account reflects a significant amount of transaction at gas stations, etc. This lifestyle related data provides information relating to customer's spending trends. Consequently, providing information about customer's interest for a particular types of offers.

Local databases 104 may also store customers' behavior related data. The customer's behavior information includes Internet Protocol (IP) address, unique cookie identification data, web browsing patterns, online purchase history etc. In various embodiments, the customer's personal information may be entered by customer(s) 114 while creating a profile on merchant's website. Further, customers 114 may also provide their preference setting, related to the offers that they might receive from the merchant, on merchant's website. In one implementation, local databases 104 obtain the customers' behavior related data through third party sources 108. In an embodiment, third party sources 110 may include various online service providers, for example, Google Analytics, Urchin Software from Google Inc., Yahoo! Web Analytics, Omniture's Site Catalyst and the like.

In addition to the financial, lifestyle and behavioral data stored in local databases 104, offer module 112 may access data from various other third party sources 108. Third party sources 108 may be a database of a bank, a database of another merchant, a database of an airline, a social network data store, a database of a chain of retail stores and the like. For example, local databases 104 may extract data relating to income range, investment portfolio, spending patterns, household income, credit history of customers 114. In an embodiment, local databases 104 may extract one or more data, stored on the third party sources 110, and store it locally.

In an embodiment, local databases 104 may also store geography/location based customers' activities. For example, local databases 104 may store various transactional data associated with customers 114 based on location information of the customers 114. Local databases 104 may tag the various transactional data based on the location where the transactions are done by customers 114. Thus, in one embodiment, the generated offer may be based on the card members transaction history and/or location. Furthermore, the generated offer may be created in real-time so that location based offers are presented to customers in a timely manner. For example, GPS technology may determine that the customer is in a particular store (or shopping area) and offers may be generated in real time, so that the customer has an opportunity to view the offer before leaving the store.

In one embodiment, offer module 112 communicates with a meteorological database (one of the third-party sources 108). Offer module 112 may be configured to extract information regarding weather conditions of a locality. In an embodiment, offer module 112 communicates with dynamic event databases (one of third-party sources 108) to obtain information regarding the various ongoing events near the customers' location. A dynamic event database may include information related to the ongoing events such as sports events, cultural events, current movies data, upcoming festival data etc. Offer module 112 may utilize this information for intelligently providing offers to customers 114.

In one embodiment, offer module 112 may be configured to obtain or receive location information of customers 114. This information may be received by a (Global Positioning System) GPS, A-GPS (Assisted-Global Positioning System), (LOng RAnge Navigation) LORAN system included in the portable device used by customers 114. The location information may also be provided by the communication service provider based on the cell-zone a user is currently located in. The location information may be utilized by offer module 112 for intelligently providing the offers to customers 114.

In an embodiment, offer module 112 is capable of receiving information regarding customers 114 from a database of social networking websites (third party sources 108). This information may be related to relationships (e.g., friends and/or family information), interests, interactions and activities of customers 114 on the networking website. This information may be utilized by offer module 112 to determine customers' areas of interest or potential and timing for making a particular type of purchase. For example, if a user of social networking websites has joined various communities related to music and movies, then the user may be offered discounts on music and movies DVDs within partner shops present in his/her locality.

Local databases 104 and offers databases 106 may employ any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, CA), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the disclosure, any suitable data storage technique may be utilized to store data without a standard format. Data sets may be stored using any suitable technique, including, for example, storing individual files using an ISO/DEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using one of fixed storage allocation, circular queue techniques, or best practices with respect to memory management (e.g., paged memory, least recently used, etc.). By using BLOB methods, the ability to store various data sets that have different formats facilitates the storage of data associated with the system by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of local database 106, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, customers or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate. The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand-alone device, the appropriate option for the action to be taken. Local databases 104 and offer database 106 contemplates a data storage arrangement wherein the header or trailer, or header or trailer history, of the data is stored on the transaction instrument in relation to the appropriate data. One skilled in the art will also appreciate that, for security reasons, any databases, systems, devices, servers or other components of local databases 104 and offer database 106 may consist of any combination thereof at a single location or at multiple locations, wherein each database or system includes any of various suitable security features, such as firewalls, access codes, encryption, decryption, compression, decompression, and/or the like.

The disclosure may be described herein in terms of functional block components, screen shots, optional selections and various processing steps. It should be appreciated that such functional blocks may be realized by any number of hardware and/or software components configured to perform the specified functions. For example, system 100 may employ various integrated circuit components, e.g., memory elements, processing elements, logic elements, look-up tables, and/or the like, which may carry out a variety of functions under the control of one or more microprocessors or other control devices. Similarly, the software elements of system 100 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that system 100 may employ any number of conventional techniques for data transmission, signaling, data processing, network control, and/or the like. Still further, system 100 could be used to detect or prevent security issues with a client-side scripting language, such as JavaScript, VBScript or the like.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

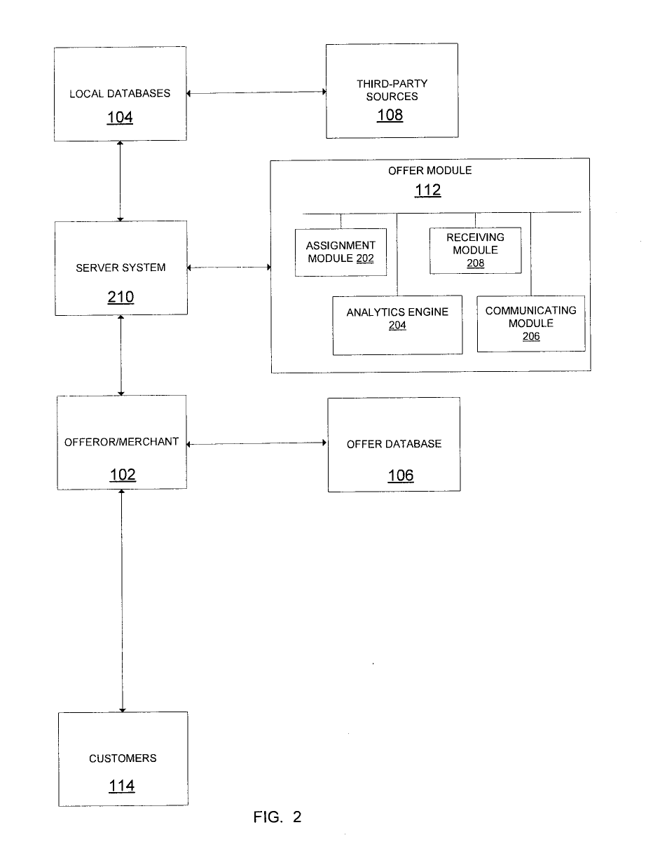

Referring to FIG. 2, an exemplary implementation of offer module 112 is depicted. As shown in FIG. 2, in an exemplary embodiment, offer module 112 may include an assignment module 202, an analytics engine 204, a communicating module 206, and a receiving module 208.

As shown in the exemplary embodiment of FIG. 2, offer module 112 is communicatively coupled to a server 210 associated with merchant 102. Further, offer module 112 may be configured to communicate with local databases 104 and third party sources 108 through communication network 110. In an embodiment, offer module 112 may provide one or more offers to customers 114 having transaction accounts associated with a rewards program. Particularly, assignment module 202 may determine an assignment for the transaction account data associated with a first transaction account. Assignment module 202 may be configured to extract the transaction account data of customers 114 through local databases 104 (as explained in conjunction with FIG. 1). The transaction account data may provide information related to the nature of transactions performed by customers 114. Further, the transaction data may also provide the information related to the nature of transactions done by customers 114 in a particular locality.

Further, assignment module 202 may assign the first transaction account associated with the rewards program to a first population of a plurality of populations based on the transaction account data of customers 114. In an embodiment, the plurality of populations may include one or more customers 114. Further, merchant 102 may select one or more offers from offer database 106 to be provided to one or more customers 114. Receiving module 206 may receive the one or more offers from merchant 102. The offers may be associated with one or more offer criteria. The offer criteria may include offer criteria data such as, for example, current or historical transaction data of customers 114, weather data, user location data, sports event data, cultural event data, holiday data, user profile data, user travel data, itinerary data, current event data and the like.

Analytics engine 204 analyzes the offer criteria to identify a subset of the plurality of populations. In an embodiment, the subset of the plurality of populations includes the first population to which the first transaction account is associated. Further, analytics engine 204 analyzes the offer criteria with respect to the preference setting of customers 114 received by receiving module 208. The preference setting may be associated with at least one of, for example, a product category of interest to customers 114, a trademark, a company, a merchant, a merchant type, an event type, a cultural preference, a religious preference, a food preference, a location, an activity, a travel preference, and weather preference.

In an embodiment, analytics engine 204 determines if a trigger condition with respect to the offer criteria is met. For example, if according to an available data related to the customer, the customer is interested in cultural events, then analytics engine 204 selects the offers that may provide discounts on cultural events tickets. Further, analytics engine 204 may also determine the location of customers 114 to further customize the offers based on the location data.

In one embodiment, if the trigger condition is being met, then communicating module 206 communicates the offer to the identified subset of populations (customers 114). Customers 114 may also define the channel of interest such as, for example, Short Messaging Service (SMS), Multimedia Messaging (MMS), E-mail, and the like to receive the offers. Communicating module 206 may communicate the offer by at least one of e-mail, social networking media, text message, multimedia message, sending a gift card and the like.

In various embodiments, the offers may be either pulled/chosen by customers 114 or may be pushed on mobile communication device of customers 114. In an exemplary embodiment, where customers 114 may pull/choose the offers, analytics engine 204 may compare the offer criteria with the preference setting of customers 114 and subsequently, customizes offers to be chosen by customers 114. In an exemplary embodiment, based on customers' location, customers 114 may activate a client application in the mobile communication device to know offers related to his interest within that location. In such cases, offer module 112 may also receive an opt-in to the various offers that may be provided by merchant 102, based on which communicating module 206 may communicate the offers. The opt-in may be received from customers 114 via e-mail, multimedia message, a micro application running on customer's device, a location program running on customers' device and the like. Subsequently, offer module 112 may provide the relevant offer to customers 114 based on at least one of offer criteria, preference setting of customers 114 and a location of customers 114. For example, if a particular customer is in the market for buying merchandize, then offer module 112 may provide him discount coupons for purchasing winter garments, such as jackets, based on offer criteria (local weather conditions), preference setting (leather garments) and location (Georgetown shopping district, Washington, D.C.) of the particular customer.

In another embodiment, where the offers are pushed to the customers' mobile communication device, analytics engine 202 compares the offer criteria with the customers' data available through the local databases and/or the preference setting of the customers to provide the offers relevant to customers 114. The offers may be provided by means of e-mail, social networking media, text message, multimedia message, sending a gift card and the like. In such cases, analytics engine 202 may utilize customers' lifestyle related data, financial data, social networking data, purchase transaction history data, local weather conditions, upcoming events (sports events, cultural events, movies, theater and the like) of interest to customers 114, retrieved from local databases 104 for determining offers relevant to customers 114. For example, if a customers' transaction card information reveals that the customer is a frequent-flier, then the customer may be provided a transaction account purchase incentive offer giving him/her a certain percentage of cash-back on tickets booked through the company's transaction account for a partner airlines' ticket. In another example, if the data from transaction records of a particular customer reflect a significant spending in electronic products, then analytics engine 202 may provide discount coupons for electronic items in nearby shops.

In an exemplary embodiment, analytics engine 202 customizes offers based on the itinerary data which may include customers' itinerary data, friend itinerary data, friend location data, and family location data. The location data may be determined based on the at least one of, for example, user mobile device, merchant location, social networking information.

Receiving module 208 receives the acceptance of the offer from customer 114 associated with the first transaction account. In an exemplary embodiment, the acceptance is received via e-mail, multimedia message, a micro application running on customer's mobile communication device, a location program running on customers' mobile communication device or the like. The acceptance may include a purchase transaction associated with the offer. In an embodiment, analytics engine 202 monitors the transaction associated with the first transaction account and the provided offer.

Analytics engine 202 may compare the purchase transaction with a reward criteria associated with the offer. The reward criteria may include one or more parameters for providing a reward associated with the offer. The reward may include, for example, a discount, a rebate, eligibility for a second offer, an accumulation of points, eligibility of a second offer for a related transaction account. For example, the reward criteria associated with the offer may include providing a 10% discount to the customer if the customer purchases merchandize worth of $500 from a list of merchants provided in the associated offer. Analytics engine 202 determines the reward based on the offer, the purchase transaction and the reward criteria. In another embodiment, if the purchase transaction is initiated using the gift card, instead of the purchase transaction, then analytics engine 202 may determine the award associated with the offer based on the value of the gift card and the reward criteria.

In an embodiment, analytics engine 202 receives notification associated with the reward criteria to determine if the reward criteria are met. Further, in response to the determining that the reward criteria have been met, analytics engine 202 may apply the reward associated with the offer to the first transaction account, with which the rewards program is associated.

In an embodiment, analytics engine 202 updates local databases 104 with the offer acceptance from one or more customers 114 and the merchant account history associated with the offer. The updated information may be further utilized by analytics engine 202 to provide offers to one or more customers 114.

### III. Process overview

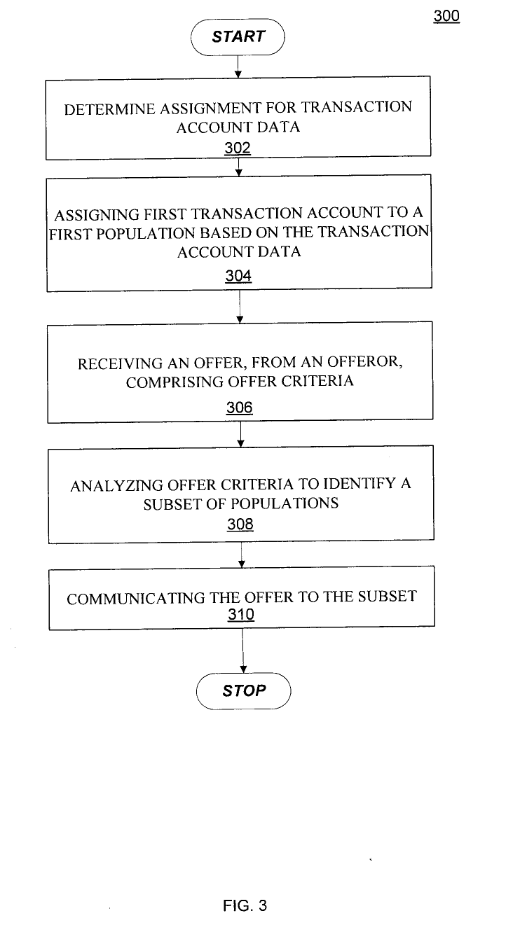

FIG. 3 is a flowchart illustrating an example process 300 for providing relevant offers to customers 114.

Offer module 112 is communicatively coupled to the server 210 associated with merchant 102. Further, offer module 112 may be configured to communicate with local databases 104 and third party sources 108 through communication network 110. In an embodiment, offer module 112 may provide one or more offers to customers 114 associated with a rewards program.

Offer module 112 may determine an assignment for the transaction account data associated with a first transaction account. (step 302). Offer module 112 may be configured to extract the transaction account data of customers 114 through local databases 104.

Offer module 112 may assign the first transaction account associated with the rewards program to a first population of a plurality of populations based on the transaction account data of customers 114 (step 304). In an embodiment, the plurality of populations may include one or more customers 114.

In an embodiment, merchant 102 selects one or more offers from offer database 106 to be provided to one or more customers 114. Offer module 112 receives the one or more offers from merchant 102 (step 306). The offers may be associated with one or more offer criteria. The offer criteria may include offer criteria data such as, for example, current or historical transaction data of customers 114, weather data, user location data, sports event data, cultural event data, holiday data, user profile data, user travel data, itinerary data, current event data and the like.

Offer module 112 analyzes the offer criteria to identify a subset of the plurality of populations (step 308). In an exemplary embodiment, the subset of the plurality of populations includes the first population to which the first transaction account is associated.

In one embodiment, offer module 112 analyzes the offer criteria with respect to the preference setting of customers 114 received by the receiving module. The preference setting may be associated with at least one of, for example, a product category of interest to customers 114, a trademark, a company, a merchant, a merchant type, an event type, a cultural preference, a religious preference, a food preference, a location, an activity, a travel preference, and weather preference.

Further, offer module 112 may determine if a trigger condition with respect to the offer criteria is met. In an embodiment, if the trigger condition is being met, then offer module 112 communicates the offer to the identified subset of populations (step 310). Offer module 112 may communicate the offer by at least one of e-mail, social networking media, text message, multimedia message, sending a gift card and the like.

In various embodiments, the offers may be either pulled/chosen by customers 114 or may be pushed on mobile communication device of customers 114. In an exemplary embodiment, where customers 114 may pull/choose the offers, offer module 112 may compare the offer criteria with the preference setting of customers 114 and subsequently, customizes offers to be chosen by customers 114. In such cases, offer module 112 may also receive an opt-in to the various offers that may be provided by merchant 102, based on which offer module 112 may communicate the offers. The opt-in may be received from customers 114 via e-mail, multimedia message, a micro application running on customer's device, a location program running on customers' device and the like. Subsequently, offer module 112 may provide the relevant offer to customers 114 based on at least one of offer criteria, preference setting of customers 114 and a location of customers 114. In an embodiment, offer module 112 is configured to generate offers automatically. For example, artificial intelligence and/or statistical techniques may be used to create new offers based upon transaction history, merchant inventory, merchant cash-flow, transaction account balance (or available balance), payment history, and/or the relative success of previous offers. In an embodiment, an automatically generated offer may be communicated to a merchant for approval but an automatically generated offer may also be sent directly to customers.

In an embodiment, where the offers are pushed on the customers' mobile communication device, offer module 112 may compare the offer criteria with customer data available through the local databases and/or the preference setting of the customers to provide the offers relevant to customers 114. The offers may be provided by means of, for example, e-mail, social networking media, text message, multimedia message, sending a gift card and the like. In such cases, offer module 112 may utilize customers' lifestyle related data, financial data, social networking data, purchase transaction history data, local weather conditions, upcoming events (sports events, cultural events, movies, theater and the like) of interest to customers 114, retrieved from local databases 104 for determining offers relevant to customers 114.

In an exemplary embodiment, offer module 112 customizes offers that may be based on the itinerary data which may include customers' itinerary data, friend itinerary data, friend location data, and family location data. The location data may be determined based on the at least one of, for example, user mobile device, merchant location, social networking information.

Offer module 112 receives the acceptance of the offer from customer 114 associated with the first transaction account. In an exemplary embodiment, the acceptance may be received via e-mail, multimedia message, a micro application running on customer's device, a location program running on customers' device and the like. The acceptance may include a purchase transaction associated with the offer. In an embodiment, offer module 112 may monitor the transaction associated with the first transaction account and the provided offer.

Offer module 112 compares the purchase transaction with a reward criteria associated with the offer. The reward criteria may include one or more parameters for providing a reward associated with the offer. The reward may include, for example, a discount, a rebate, eligibility for a second offer, an accumulation of points, eligibility of a second offer for a related transaction account. Subsequently, offer module 112 may determine the appropriate reward based on the offer, the purchase transaction and the reward criteria. In embodiment, the system is configured to receive a request to redeem loyalty points for a monetary value. For example, the monetary value can be applied to particular eligible transactions associated with a transaction account. For more information regarding systems and methods for redeeming points, see U.S. patent application Ser. No. 12/847,832 entitled “Use Points for Everyday Charges/Everyday Redemptions,” filed on Jul. 30, 2010 which is hereby incorporated by reference in its entirety.

In an embodiment, offer module 112 may receive notification associated with the reward criteria to determine if the reward criteria are met. Further, in response to the determining that the reward criteria have been met, offer module 112 may apply the reward associated with the offer to the first transaction account, with which the rewards program is associated.

While the steps outlined above represent a specific embodiment, practitioners will appreciate that there are any number of computing algorithms and user interfaces that may be applied to create similar results. The steps are presented for the sake of explanation only and are not intended to limit the scope of the disclosure in any way.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the disclosure. It should be understood that the detailed description and specific examples, indicating exemplary embodiments, are given for purposes of illustration only and not as limitations. Many changes and modifications within the scope of the instant disclosure may be made without departing from the spirit thereof, and the disclosure includes all such modifications. Corresponding structures, materials, acts, and equivalents of all elements in the claims below are intended to include any structure, material, or acts for performing the functions in combination with other claim elements as specifically claimed. The scope of the disclosure should be determined by the appended claims and their legal equivalents, rather than by the examples given above. Reference to an element in the singular is not intended to mean “one and only one” unless explicitly so stated, but rather “one or more.” Moreover, where a phrase similar to ‘at least one of A, B, and C is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

### IV. Example Implementations

The present disclosure (i.e., analytics module 112, process 300, any part(s) or function(s) thereof) may be implemented using hardware, software or a combination thereof, and may be implemented in one or more computer systems or other processing systems. However, the manipulations performed by the present disclosure were often referred to in terms, such as comparing or checking, which are commonly associated with mental operations performed by a human operator. No such capability of a human operator is necessary, or desirable in most cases, in any of the operations described herein, which form a part of the present disclosure. Rather, the operations are machine operations. Useful machines for performing the operations in the present disclosure may include general-purpose digital computers or similar devices.

In fact, in accordance with an embodiment, the present disclosure is directed towards one or more computer systems capable of carrying out the functionality described herein.

The computer system 400 includes at least one processor, such as a processor 402. Processor 402 is connected to a communication infrastructure 404, for example, a communications bus, a cross over bar, a network, and the like. Various software embodiments are described in terms of this exemplary computer system 400. After reading this description, it will become apparent to a person skilled in the relevant art(s) how to implement the present disclosure using other computer systems and/or architectures.

The computer system 400 includes a display interface 406 that forwards graphics, text, and other data from the communication infrastructure 404 (or from a frame buffer which is not shown in FIG. 11) for display on a display unit 408.

The computer system 400 further includes a main memory 410, such as random access memory (RAM), and may also include a secondary memory 412. The secondary memory 412 may further include, for example, a hard disk drive 414 and/or a removable storage drive 416, representing a floppy disk drive, a magnetic tape drive, an optical disk drive, etc. The removable storage drive 416 reads from and/or writes to a removable storage unit 418 in a well known manner. The removable storage unit 418 may represent a floppy disk, magnetic tape or an optical disk, and may be read by and written to by the removable storage drive 416. As will be appreciated, the removable storage unit 418 includes a computer usable storage medium having stored therein, computer software and/or data.

In accordance with various embodiments of the present disclosure, the secondary memory 412 may include other similar devices for allowing computer programs or other instructions to be loaded into the computer system 400. Such devices may include, for example, a removable storage unit 420, and an interface 422. Examples of such may include a program cartridge and cartridge interface (such as that found in video game devices), a removable memory chip (such as an erasable programmable read only memory (EPROM), or programmable read only memory (PROM)) and associated socket, and other removable storage units 420 and interfaces 422, which allow software and data to be transferred from the removable storage unit 420 to the computer system 400.

The computer system 400 may further include a communication interface 424. The communication interface 424 allows software and data to be transferred between the computer system 400 and external devices. Examples of the communication interface 424 include, but may not be limited to a modem, a network interface (such as an Ethernet card), a communications port, a Personal Computer Memory Card International Association (PCMCIA) slot and card, and the like. Software and data transferred via the communication interface 424 are in the form of a plurality of signals, hereinafter referred to as signals 426, which may be electronic, electromagnetic, optical or other signals capable of being received by the communication interface 424. The signals 426 are provided to the communication interface 424 via a communication path (e.g., channel) 428. The communication path 428 carries the signals 426 and may be implemented using wire or cable, fiber optics, a telephone line, a cellular link, a radio frequency (RF) link and other communication channels.

In this document, the terms “computer program medium” and “computer usable medium” are used to generally refer to media such as the removable storage drive 416, a hard disk installed in hard disk drive 414, the signals 426, and the like. These computer program products provide software to the computer system 400. The present disclosure is directed to such computer program products.

Computer programs (also referred to as computer control logic) are stored in the main memory 410 and/or the secondary memory 412. Computer programs may also be received via the communication interface 404. Such computer programs, when executed, enable the computer system 400 to perform the features of the present disclosure, as discussed herein. In particular, the computer programs, when executed, enable the processor 402 to perform the features of the present disclosure. Accordingly, such computer programs represent controllers of the computer system 400.

In accordance with an embodiment, where the disclosure is implemented using a software, the software may be stored in a computer program product and loaded into the computer system 400 using the removable storage drive 416, the hard disk drive 414 or the communication interface 424. The control logic (software), when executed by the processor 402, causes the processor 402 to perform the functions of the present disclosure as described herein.

In another embodiment, the present disclosure is implemented primarily in hardware using, for example, hardware components such as application specific integrated circuits (ASIC). Implementation of the hardware state machine so as to perform the functions described herein will be apparent to persons skilled in the relevant art(s).

In yet another embodiment, the present disclosure is implemented using a combination of both the hardware and the software.

### V. Conclusion

While various embodiments of the present disclosure have been described above, it should be understood that they have been presented by way of example, and not limitation. It will be apparent to persons skilled in the relevant art(s) that various changes in form and detail can be made therein without departing from the spirit and scope of the present disclosure. Thus, the present disclosure should not be limited by any of the above described exemplary embodiments, but should be defined only in accordance with the following claims and their equivalents.

In addition, it should be understood that the figures illustrated in the attachments, which highlight the functionality and advantages of the present disclosure, are presented for example purposes only. The architecture of the present disclosure is sufficiently flexible and configurable, such that it may be utilized (and navigated) in ways other than that shown in the accompanying figures.

1. A computer based method, comprising:
determining, by a computer based system for managing a rewards program, an assignment for transaction account data associated with a first transaction account;
assigning, by the computer based system, the first transaction account to a first population of a plurality of populations based on the transaction account data;
receiving, by the computer based system and from an offeror, an offer comprising offer criteria;
analyzing, by the computer based system, the offer criteria to identify a subset of the plurality of populations, wherein the subset comprises the first population; and
communicating, by the computer based system, the offer to the subset.

2. The method of claim 1, further comprising receiving, from a user associated with the first transaction account, an acceptance of the offer.

3. The method of claim 2, wherein the acceptance is received from a mobile device.

4. The method of claim 2, wherein the acceptance comprises a purchase transaction associated with the offer.

5. The method of claim 2, wherein the offer comprises reward criterion and a reward.

6. The method of claim 5, wherein the reward comprises at least one of a discount, a rebate, eligibility for a second offer, an accumulation of points, eligibility of a second offer for a related transaction account.

7. The method of claim 5, further comprising receiving notification associated with the reward criterion and determining that the reward criterion has been met.

8. The method of claim 7, further comprising, in response to the determining that the reward criterion has been met, applying the reward to the transaction account.

9. The method of claim 1, further comprising analyzing offer criteria data to determine a trigger condition has been met, wherein the offer criteria data comprises at least one of transaction data, weather data, user location data, event data, sports event data, cultural event data, holiday data, user profile data, user travel data, itinerary data and current event data.

10. The method of claim 9, wherein the communicating is performed in response to the trigger condition being met.

11. The method of claim 9, wherein the itinerary data comprises at least one of user itinerary data, friend itinerary data, friend location data and family location data.

12. The method of claim 9, wherein the location information is determined based upon at least one of a user device, a merchant location and social network information.

13. The method of claim 1, further comprising receiving, from a user associated with the first transaction account, a preference setting, wherein the analyzing further comprises analyzing the preference setting.

14. The method of claim 13, wherein the preference setting is associated with at least one of a product category, a brand, a trademark, a company, a merchant, a merchant type, an event type, a cultural preference, a religious preference, a food preference, a location, an activity a travel preference and weather preference.

15. The method of claim 1, further comprising:
associating, by the computer based system, the transaction account with a rewards program;
monitoring, by the computer based system, a transaction of the transaction account;
comparing, by the computer based system, the transaction with a reward criterion associated with the offer;
determining, by the computer based system, a reward based upon at least one of the offer, the transaction and the reward criterion.

16. The method of claim 1, wherein the offer is communicated via at least one of e-mail, social networking media, text message, multimedia message and sending a gift card.

17. The method of claim 1, further comprising determining, in response to a transaction being initiated using the gift card, an award associated with the offer.

18. The method of claim 1, further comprising receiving an opt-in to the offer, wherein the communicating occurs in response to the receiving the opt-in, and wherein the opt-in is received via email, text message, multimedia message, a micro application running on a user device and a location program running on a user device.

19. A non-transitory computer-readable storage medium having computer-executable instructions stored thereon that, if executed by a computer based system for managing a rewards program, causes the computer based system to perform operations comprising:
determining, by the computer based system, an assignment for transaction account data associated with a first transaction account;
assigning, by the computer based system, the first transaction account to a first population of a plurality of populations based on the transaction account data;
receiving, by the computer based system and from an offeror, an offer comprising offer criteria;
analyzing, by the computer based system, the offer criteria to identify a subset of the plurality of populations, wherein the subset comprises the first population; and
communicating, by the computer based system, the offer to the subset.

20. A system comprising:
a network interface communicating with a non-transitory memory;
the memory communicating with a processor; and
the processor, when executing a computer program, performs operations comprising:
determining, by the processor, an assignment for transaction account data associated with a first transaction account;
assigning, by the processor, the first transaction account to a first population of a plurality of populations based on the transaction account data;
receiving, by the processor and from an offeror, an offer comprising offer criteria;
analyzing, by the processor, the offer criteria to identify a subset of the plurality of populations, wherein the subset comprises the first population; and
communicating, by the processor, the offer to the subset.
